(19) United States
(12) Patent Application Publication
(10) Pub. No.: US 2009/0211420 A1
(43) Pub. Date: Aug. 27, 2009

(54) Cutting unit

(76) Inventor: Bernd Loibl, Klettgau (DE)

Correspondence Address: BERENATO, WHITE & STAVISH, LLC, 6550 ROCK SPRING DRIVE, SUITE 240, BETHESDA, MD, 20817, US

(21) Appl. No.: 12/388,882

(22) Filed: Feb. 19, 2009

(30) Foreign Application Priority Data
Feb. 21, 2008 (DE) 202008002453.8

(51) Int. Cl. B26D 1/18; B26D 1/06

(52) U.S. Cl. 83/485; 83/697

(57) ABSTRACT

A cutting unit for trimming sheet material has a support plate forming a support surface for supporting the sheet material and having a cutting device that comprises a guide bar extending over the support plate. A knife carriage having a cutting knife is displaceably guided on the bar. The bar is mounted in a pivot bearing pivotably about a pivot axis. The pivot axis proceeds perpendicularly to the support surface.

The invention relates to a cutting unit for trimming sheet material in the office sector; having a support plate, forming a support surface, for supporting the sheet material; and having a cutting device that comprises a guide bar extending over the support plate, on which bar a knife carriage having a cutting knife is displaceably guided, the bar being mounted in a pivot bearing pivotably about a pivot axis.

Cutting units of the aforesaid kind are known in a great variety of embodiments and are used in the office sector in order to adjust sheet material to a desired dimension. The sheet material can be sheets of paper, photographic paper, cardboard, but also films.

Cutting units of this kind are embodied as tabletop units and have a support plate, usually rectangular in contour and serving as a base, that forms a horizontally extending support surface for supporting the sheet material that is to be trimmed. Arranged usually on one side of the support plate is a cutting device, which can be embodied in different ways. In the case of the cutting unit of the species, the cutting device comprises a guide bar, extending over the support plate, along which a knife carriage is displaceably guided. Arranged on or in the knife carriage is a cutting knife that is lowerable toward the support plate from an inactive position into a cutting position.

The cutting knife can be embodied as a rigidly mounted cutting blade. As a rule, however, rotary cutting devices are provided; these are notable for the fact that a circular knife is mounted on the knife carriage freely rotatably about an axis that extends parallel to the support surface and transversely to the longitudinal axis of the guide bar. During the cutting operation, the circular knife is lowered into the cutting position by pushing the knife carriage housing down. Upon displacement of the knife carriage, rolling of the circular knife then causes trimming of the sheet material.

Cutting units having rotary cutting devices are evident, for example, from DE 203 18 947 U1, De 201 01 479 U1, and US 2002/0092396 A1. As EP 1 475 201 A1 shows, such cutting units also can be additionally equipped with a guillotine cutting device on the side located opposite the rotary cutting device, so that a cutting device optimal for the type of sheet material to be trimmed is always available with no need to procure two cutting units for that purpose.

In the rotary cutting devices of the species, the guide bars are guided in vertically movable fashion in order to hold the sheet material in place by lowering the guide bar toward the support plate, and thus fasten it in a specific position. For this purpose, the guide bar can be mounted at the end in a pivot bearing whose pivot axis extends transversely to the longitudinal axis of the guide bar (cf. DE 201 01 479 U1, FIG. 11) or parallel to said longitudinal axis (cf. US 2002/0092396 A1). In every case, however, the orientation of the guide bar on the cutting unit is defined. Oblique cuts can therefore be made with such a cutting unit only by corresponding rotation of the sheet material itself; this is possible only to a limited extent, and a specific cut is almost impossible to repeat.

It is the object of the present invention to configure a cutting unit of the kind cited initially in such a way that with it, obliquely extending trimming of sheet material can also be effected reproducibly.

This object is achieved according to the present invention in that the pivot bearing in which the guide bar is pivotably mounted is embodied in such a way that the pivot axis proceeds perpendicularly to the support surface. This embodiment of the pivot axis creates the possibility of pivoting the guide bar in a plane parallel to the support surface and thus placing it obliquely at a desired angle with respect to a sheet item resting on the support plate, thereby performing a corresponding trimming cut. All that is necessary in order for that cut to be reproducible is that the respective subsequent sheet item be brought into a defined position on the support plate (in the existing art this is normally done by placement against a guide bar or by alignment with reference to a linear pattern) the guide bar and by pivoting into the particular desired angular position. It may be helpful in this context to provide angle markings on the support plate which facilitate the setting of a specific angle.

In an embodiment of the invention, provision is made that the pivot bearing is arranged at one end of the guide bar; although this need not absolutely be the case, it is nevertheless advisable. By preference, the pivot bearing should be arranged in the edge region of a first side of the support plate, advisably so that the pivot bearing is arranged in a corner region of the first side of the support plate with respect to a second side of the support plate that proceeds perpendicularly to the first side. This is a particularly good choice when the support plate has a rectangular contour.

According to the invention, the pivot bearing is to comprise a bar-side first bearing part and a plate-side second bearing part complementary thereto, the first bearing part being separable from the second. This can be accomplished, for example, in such a way that the bearing parts are embodied in one case as a bearing pin and in the other as a pin receptacle enclosing the bearing pin, the pin receptacle usefully forming the second bearing part and being embodied, for example, as a depression in the support plate. The separability of the bearing parts has the advantage that the guide bar can also be removed, for example so that it can be used for cutting operations, together with the knife carriage, outside the cutting unit. This also creates the possibility of shifting the pivot bearing to a different location on the support plate, if the support plate comprises at least one further second bearing part that is connectable to the first bearing part to form a pivot bearing. The pivot point on the support plate can in this way be displaced so that trimming of the sheet material in any desired directions is possible. Usefully, two second bearing parts are arranged on two sides of the support plate that are connected to one another by a corner and that, by preference, proceed at right angles to one another. The two second bearing parts should each be arranged in the halves of their sides that are adjacent to the corner.

The guide bar can have, at its free end, no connection to the support plate, so that it is freely movable there. The possibility also exists, however, of the guide bar being connectable or connected, in the region of one end, to the support plate via a fastening device by means of which the guide bar is securable in multiple angular positions around the pivot axis. In this fashion, the angular position is maintained in the context of the cutting operation with no need to secure it by hand. The fastening device can, for example, comprise a slider that is displaceable in a guide and can be clamp-locked to the guide for fastening purposes and is connected or releasably connectable to the guide bar of the cutting apparatus. In order to keep the support plate unencumbered by the fastening device, the slider should be guided on one side of the support plate, parallel to the side, in a linear guide, and connected to the guide bar in articulated fashion and displaceably in its longitudinal direction. The latter can be implemented by the fact that the slider comprises a pin around which fits a groove extending in a longitudinal direction of the guide bar, so that the guide bar and slider can easily be separated from one another. The linear guide should be arranged on the outer edge of the support plate. The slider preferably has a clamping device with which releasable clamp-locking to the linear guide can be effected.

The cutting knife can be embodied as a cutting blade secured on the knife carriage. It is preferred, however, if the cutting device is embodied as a rotary cutting device in which a circular knife constituting a cutting knife is rotatably mounted on or in the knife carriage, as is known per se in the existing art. This is because a particularly precise and smooth cut can be achieved with a circular knife.

Lastly, provision is made according to the present invention that the guide bar is pressable against the support plate so as thereby to make possible retention, between the guide bar and support plate, of the sheet item to be trimmed.

The invention is illustrated further, with reference to an exemplifying embodiment, in the drawings, in which:

FIG. 1 is an oblique view from above of the cutting unit according to the present invention;

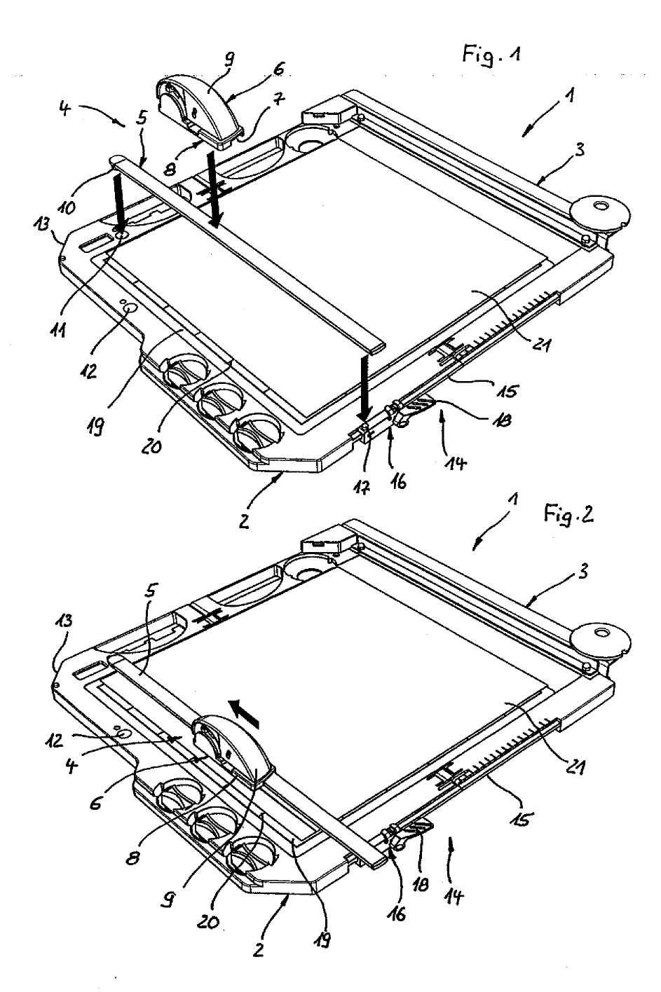

FIG. 2 is an oblique view from above of the cutting unit according to the present invention with the cutting device installed;

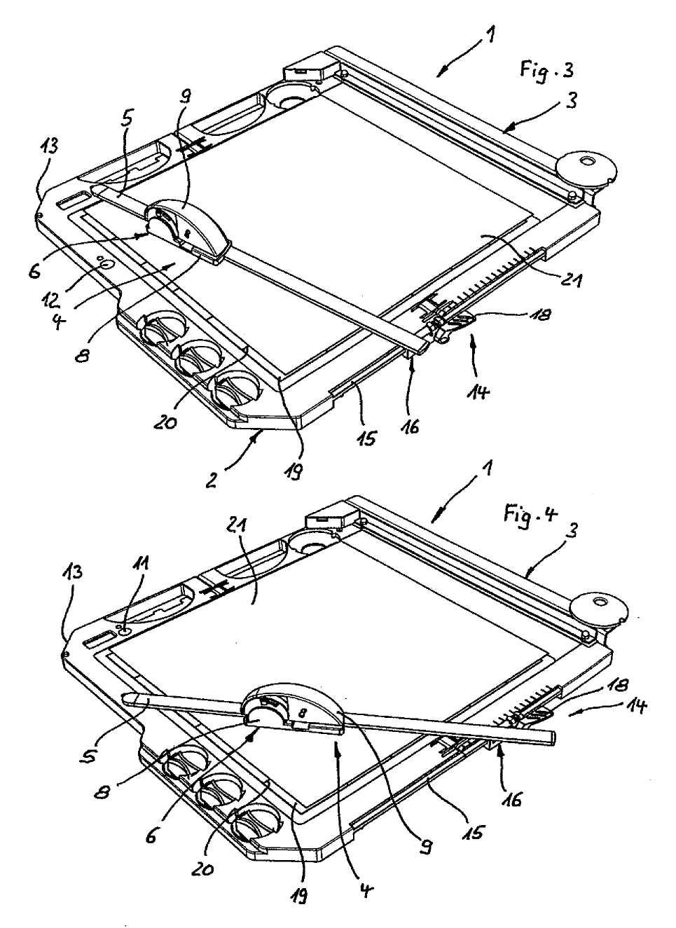

FIG. 3 shows the cutting unit according to FIGS. 1 and 2 with the cutting device positioned obliquely, in the same view as in FIG. 2;

FIG. 4 is likewise an oblique view from above of the cutting unit according to FIGS. 1 and 3, with the cutting device in a position modified as compared with FIG. 3;

FIG. 5 is a side view of the knife carriage for the cutting device of the cutting unit according to FIGS. 1 to 4, in the inactive position;

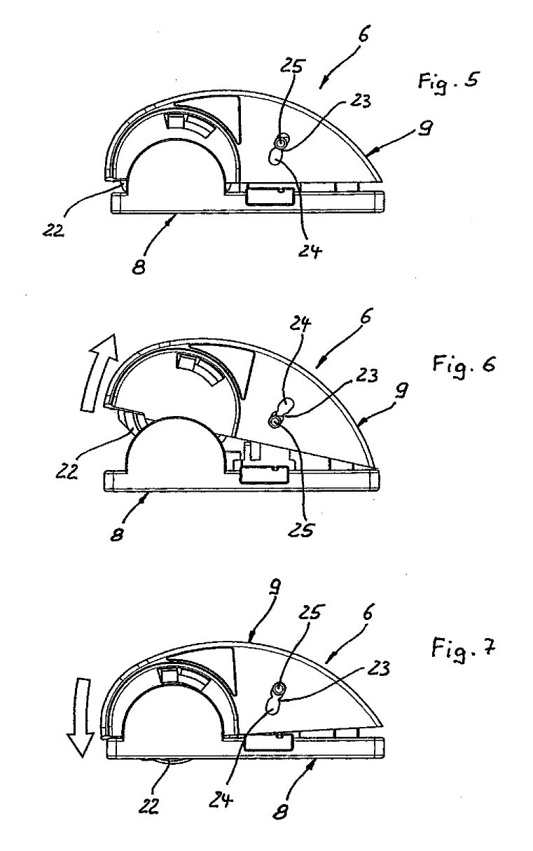

FIG. 6 is a side view of the knife carriage according to FIG. 5 in a knife-changing position;

FIG. 7 shows the knife carriage according to FIGS. 5 and 6 in the cutting position.

Cutting unit 1 depicted in FIGS. 1 to 4 comprises a support plate 2 having a substantially rectangular contour. A guillotine cutting device 3 on the one hand, and a rotary cutting device 4 on the other hand, are provided on oppositely located sides of support plate 2. Because guillotine cutting device 3 is not a subject of the present invention, it is not further described below. Reference is instead made to EP 1 475 201 A1, which likewise discloses a combination of a guillotine cutting device and rotary cutting device within a single cutting unit.

Rotary cutting device 4 comprises a guide bar 5 that is embodied as a simple elongated bar of rectangular cross section. Part of rotary cutting device 4 is a knife carriage 6 that comprises on the lower side a guide groove 7 into which guide bar 5 fits when knife carriage 6 is placed onto guide bar 5 from the position depicted in FIG. 1, in accordance with the arrow therein, into the position depicted in FIG. 2. Guide bar 5 and guide groove 7 then effect linear guidance in the longitudinal direction of guide bar 5.

Knife carriage 6 has on the lower side a slide 8 into whose lower side guide groove 7 is shaped, and on the upper side a knife housing 9 that is mounted on slide 8 pivotably about an axis extending parallel to support plate 2 and transversely to the longitudinal axis of guide bar 5. A circular knife is mounted in knife housing 9, freely rotatably about an axis extending parallel to the pivot axis of knife housing 9.

Guide bar 5 has on the lower side, at the end located remotely in the views according to FIGS. 1 to 4, a bearing pin 10 that projects downward. The cylindrical bearing pin 10 fits into two likewise cylindrical pin receptacles 11, 12; the one pin receptacle 11 is shaped into the region of a first side of support plate 2 close to a corner 13 with respect to a second side of support plate 2 that proceeds at right angle to the first side, while second pin receptacle 12 is provided in the region of the second side, but somewhat farther away from corner 13 than first pin receptacle 11. Guide bar 5 can be inserted, with bearing pin 10, into one of the two pin receptacle 11, 12 and is then pivotable about a vertical axis through bearing pin 10 and the respective pin receptacle 11 or 12.

A fastening device 14 is provided on a third side parallel to the first. Said device comprises a linear guide 15 which extends along the third side and on which a slider 16 is guided in longitudinally displaceable fashion. Slider 16 comprises on the upper side an upwardly projecting cylindrical coupling pin 17 which matches a guide groove that is shaped into the lower side of guide bar 5 and extends in its longitudinal axis. In the positions according to FIGS. 2 to 4, guide bar 5 is placed onto slider 16 in such a way that coupling pin 17 fits into said guide groove.

Slider 16 comprises a clamping cam (not depicted here in further detail) that is rotatable by way of a pivotable hand lever 18 on slide 16 in such a way that it is movable from an inactive position into a clamped position in which it abuts under preload against linear guide 15, and in that manner secures slider 16 with respect to linear guide 15.

Support plate 2 constitutes, on the upper side, a support surface 19 that is equipped with a grid-shaped linear pattern 20. A sheet 21 of paper to be trimmed is laid onto support surface 19 in alignment with linear pattern 20. Instead of or in combination with linear pattern 20, it is also possible to provide a lateral stop bar which is known e.g. from EP 1 475 201 A1 and against which sheet 21 of paper can be aligned.

For a cutting operation, guide bar 5 is placed onto support plate 2 in such a way that on the one hand its bearing pin 10 fits into one of the two pin receptacles 11 or 12, and on the other hand the guide groove present on the lower side receives coupling pin 17 of slider 16. When slider 16 is in the clamped position, guide 5 is then secured in terms of its orientation.

In the position according to FIG. 2, bearing pin 10 is inserted into first pin receptacle 11 and slider 16 is in a terminal position in which coupling pin 17 is located diametrically opposite pin receptacle 11. Guide bar 5 correspondingly extends parallel or perpendicular to the lines of linear pattern 20, i.e. the orientation corresponds to the orientation of guide bars in rotary cutting devices of ordinary design. When sheet 21 of paper is aligned with linear pattern 20, a trimming cut parallel to the lower edge of sheet 21 of paper can be performed (as is evident from FIG. 2) by pushing down knife housing 9 in order to press the circular knife into sheet 21 of paper and then sliding knife carriage 6 manually in the direction of the arrow depicted, the cutting operation being effected by rolling of the circular knife in a manner known per se.

The position of guide bar 5 visible in FIG. 3 differs from that of FIG. 2 in that after release of the clamping device to be actuated via hand lever 18, slider 16 has been slid toward guillotine cutting device 3 and has then once again been clamp-fastened by pivoting the hand lever 18. As a result, guide bar 5 has been set obliquely with reference to linear pattern 20, i.e. it has been pivoted, parallel to support surface 19, about bearing pin 10 and pin receptacle 11. Oblique trimming of sheet 21 of paper can thus be accomplished by pushing down knife housing 9 and displacing knife carriage 6 along guide bar 5.

For the position according to FIG. 4, guide bar 5 has been lifted away from support plate 2 and then moved so that bearing pin 10 has been inserted into second pin receptacle 12. At the same time, slider 16 has been displaced even farther toward guillotine cutting device 3. This results in a larger angle with respect to linear pattern 20, with a corresponding trimming capability. It is understood that variability in terms of the angular position of guide bar 5 can be increased by providing even more pin receptacles in the edge region of support plate 2, and by providing a second fastening device on the side on which first pin receptacle 11 is shaped in.

FIGS. 5 to 7 show knife carriage 6 (without guide bar 5) in a side view. In FIG. 5, the hood-shaped knife housing 9 is in the inactive position. In this position, circular knife 22 protrudes with its lower region into an open slot in slide 8, but does not project downward beyond its lower side. Knife housing 9 is held in this position by a spring (not depicted in further detail here) that pushes upward the portion of knife housing 9 in which circular knife 22 is mounted. The position is delimited at the top by a constriction 23 in a slot 24 in the side of knife housing 9 into which fits, from inside, a stud 25 that is connected rigidly to slide 8. Constriction 23 then functions as a stop.

It is evident from FIG. 6 that constriction 23 is intended merely to produce an increased resistance. Specifically, knife housing 9 has been manually pivoted clockwise and upward with respect to slide 8, stud 25 having gone past constriction 23 in slot 24 and having come into contact against its lower end. In this position, circular knife 22 is removable from the side facing away in this view and is replaceable by another circular knife, for example one that produces a wavy cut or perforations.

For the cutting operation, knife housing 9 has force exerted on it from above in such a way that it is rotated counter-clockwise (cf. the arrow depicted in FIG. 7). In the course of this motion, circular knife 22 passes through the slot in slide 8 and then projects on the lower side beyond slide 8. The motion is limited by the upper end of slot 24. In this position, sheet 21 of paper resting on support plate 2 is penetrated by circular knife 22. Displacement of knife carriage 6 along guide bar 5 then produces a cut edge in sheet 21 of paper.

1. A cutting unit (1) for trimming sheet material (21), having a support plate (2), forming a support surface (19), for supporting the sheet material (21), and having a cutting device (4) that comprises a guide bar (5) extending over the support plate (2), on which bar a knife carriage (6) having a cutting knife (22) is displaceably guided, the bar being mounted in a pivot bearing pivotably about a pivot axis,
wherein the pivot axis proceeds perpendicularly to the support surface (19).

2. The cutting unit according to claim 1, wherein the pivot bearing is arranged at one end of the guide bar (5).

3. The cutting unit according to claim 1, wherein the pivot bearing is arranged in the edge region of a first side of the support plate (2).

4. The cutting unit according to claim 3, wherein the pivot bearing is arranged in the corner region of the first side of the support plate (2) with respect to a second side that proceeds perpendicularly to the first side.

5. The cutting unit according to claim 1, wherein the pivot bearing comprises a bar-side first bearing part (10) and a plate-side second bearing part (11, 12) complementary thereto, the first bearing part (10) being separable from the second bearing part (11, 12).

6. The cutting unit according to claim 5, wherein the bearing parts are embodied in one case as a bearing pin (10) and in the other as a pin receptacle (11, 12) enclosing the bearing pin (10).

7. The cutting unit according to claim 6, wherein the pin receptacle (11, 12) forms the second bearing part.

8. The cutting unit according to claim 7, wherein the pin receptacle is embodied as a depression in the support plate (2).

9. The cutting unit according to claim 5, wherein the support plate (2) comprises at least one further second bearing part (12) that is connectable to the first bearing part (10) to form a pivot bearing.

10. The cutting unit according to claim 9, wherein two second bearing parts (11, 12) are arranged on two sides of the support plate (2) that are connected to one another by a corner (13).

11. The cutting unit according to claim 10, wherein the two second bearing parts (11, 12) are each arranged in the halves that are adjacent to the corner (13).

12. The cutting unit according to claim 1, wherein the guide bar (5) is connectable or connected, in the region of one end, to the support plate (2) via a fastening device (14) by means of which the guide bar (5) is securable in multiple angular positions around the pivot axis.

13. The cutting unit according to claim 12, wherein the fastening device comprises a slider (16) that is displaceable in a guide (15) and can be clamp-locked to the guide (15) and is connected or connectable to the guide bar (5).

14. The cutting unit according to claim 13, wherein the slider (16) is guided on one side of the support plate (2), parallel to the side, in a linear guide (15), and is connected to the guide bar (5) in articulated fashion and displaceably in its longitudinal direction.

15. The cutting unit according to claim 14, wherein the slider (16) comprises a pin (17) around which fits a groove extending in a longitudinal direction of the guide bar (5).

16. The cutting unit according to claim 14, wherein the linear guide (15) is arranged on the outer edge of the support plate (2).

17. The cutting unit according to claim 14, wherein the slider (16) has a clamping device (18) for releasable clamp-locking to the linear guide (15).

18. The cutting unit according to claim 1, wherein the cutting device is embodied as a rotary cutting device (4) in which a circular knife (22) constituting a cutting knife is rotatably mounted on or in the knife carriage (6).

19. The cutting unit according to claim 1, wherein the guide bar (5) is pressable against the support plate (2).
